(19) United States
(12) Patent Application Publication
(10) Pub. No.: US 2014/0009960 A1
(43) Pub. Date: Jan. 9, 2014

(54) BACKLIGHT DEVICE

(71) Applicants: Tomonori Miyamoto, Konohana-ku (JP); Akiyoshi Kanemitsu, Niihama-shi (JP)

(72) Inventors: Tomonori Miyamoto, Konohana-ku (JP); Akiyoshi Kanemitsu, Niihama-shi (JP)

(73) Assignee: SUMITOMO CHEMICAL COMPANY, LIMITED, Chuo-ku, Tokyo (JP)

(21) Appl. No.: 14/002,226

(22) PCT Filed: Feb. 29, 2012
(86) PCT No.: PCT/JP2012/055110

§ 371 Date: Sep. 27, 2013

(30) Foreign Application Priority Data
Mar. 2, 2011 (JP) 2011-044918

(51) Int. Cl. F21V 8/00

(52) U.S. Cl. CPC G02B 6/0055
USPC 362/606

(57) ABSTRACT

In the case where, at first to fourth azimuths being angles of 0°, 45°, 90°, and 135° with respect to a second direction from a light source (13) to a light guide plate (12) of the surface emitting part in a plane perpendicular to a first direction from the surface emitting part to the light deflecting layer, luminance is measured at a predetermined distance from a measurement target point on a light exit surface of the surface emitting part in ranges of vision of −40° to +40°, −60° to −74°, and +60° to +74° with respect to the first direction, all luminance values in the range of vision of −40° to +40° at the first to fourth azimuths are not more than 40% of a maximum of luminance values in the ranges of vision of −60° to −74° and +60° to +74° at the first to fourth azimuths.

### TECHNICAL FIELD

The present invention relates to a backlight device used in a liquid crystal display device which is used for liquid crystal display TVs, LCD monitors, personal computers, and so on.

### BACKGROUND ART

A liquid crystal display device is roughly composed of a backlight device serving as a light source, and a liquid crystal cell for displaying an image by using light emitted from the light source.

The liquid crystal display device is required to exhibit high luminance when viewed from the front and the backlight device used therein is one in which a prism sheet or a lens sheet having a light condensing property is arranged on the liquid crystal cell side of the surface light source.

Proposed for further improvement in luminance when viewed from the front is a backlight device produced by arranging a combination of a light diffusing plate containing non-spherical particles, with the lens sheet (see Patent Literature 1).

### CITATION LIST

### Patent Literature

Patent Literature 1: Japanese Patent Application Laid-Open Publication No. 2010-44269

### SUMMARY OF INVENTION

### Technical Problem

However, it needs to bring in the non-conventional special sheet of the light diffusing plate containing the non-spherical particles, and there were demands for a backlight device that can be constructed more simply and easily and that provides a liquid crystal display device with high luminance when viewed from the front.

It is therefore an object of the present invention to provide a backlight device that can be constructed simply and easily and that provides a liquid crystal display device with high luminance when viewed from the front.

### Solution to Problem

The Inventor conducted elaborate research on the backlight device to solve the above problem. As a result, the Inventor has accomplished the present invention.

A backlight device according to the present invention comprises: a surface emitting part which emits light of a planar shape from a light exit surface; and a light deflecting layer which is provided on the surface emitting part and to which the light from the light exit surface is incident. The surface emitting part has: a light guide plate; a light source arranged on an end face of the light guide plate; and a reflective sheet arranged on a side opposite to the light deflecting layer side with respect to the light guide plate. In the case where, at a first azimuth, a second azimuth, a third azimuth, and a fourth azimuth in a plane perpendicular to a first direction being a direction from the surface emitting part to the light deflecting layer, the first to fourth azimuths being angles of 0°, 45°, 90°, and 135°, respectively, with respect to a second direction being a direction from the light source to the light guide plate, luminance of the light emitted from the light exit surface is measured at a predetermined distance from a measurement target point on the light exit surface in ranges of vision of −40° to +40°, −60° to −74°, and +60° to +74° with respect to the first direction, all luminance values in the range of vision of −40° to +40° at all the first to fourth azimuths are not more than 40% of a maximum of luminance values in the ranges of vision of −60° to −74° and +60° to +74° at all the first to fourth azimuths.

In an embodiment, all the luminance values in the range of vision of −40° to +40° at all the first to fourth azimuths may be not more than 15% of the maximum of the luminance values in the ranges of vision of −60° to −74° and +60° to +74° at all the first to fourth azimuths.

In an embodiment, the light guide plate can be a plate having a trapezoid cross section.

In an embodiment, the light guide plate may be a light guide plate having such a shape that two plates having respective trapezoid cross sections are integrated while the upper bases of trapezoids are in contact so as to be shared.

The reflective sheet may be of a mirror type.

In an embodiment, the light deflecting layer may be a prism sheet having a plurality of prisms on the surface emitting part side. In this case, each of the plurality of prisms extends in a third direction being a direction perpendicular to the first and second directions, a shape of a cross section perpendicular to the third direction of each of the plurality of prisms is a triangle, the plurality of prisms are arranged in parallel in the second direction, the vertices of the triangles being the shapes of the cross sections of the respective prisms are located on the surface emitting part side, and the bases of the triangles being the shapes of the cross sections of the respective prisms lie in a row on a straight line.

### Advantageous Effect of Invention

The present invention provides the novel backlight device that can be constructed simply and easily and that provides the liquid crystal display device with high luminance when viewed from the front thereof. By using this backlight device, the liquid crystal display device can be manufactured with high luminance when viewed from the front. For this reason, the present invention is industrially extremely useful. The liquid crystal display device using the backlight device of the present invention serves as a display with high contrast and good visibility.

### BRIEF DESCRIPTION OF DRAWINGS

FIG. 1 is a schematic drawing showing an embodiment of the present invention.

FIG. 2 is a drawing showing a liquid crystal display device using a backlight device according to an embodiment of the present invention.

FIG. 3 is a drawing showing an angular distribution of luminance of emitted light from a light guide plate of the backlight device according to an embodiment of the present invention.

FIG. 4 is a drawing showing a luminance measuring method in an embodiment of the present invention.

FIG. 5 is the measurement results of an angular distribution of luminance of emitted light from the light guide plate of the backlight device in Example 1.

FIG. 6 is a drawing showing an angular distribution of luminance of emitted light from the light guide plate in the backlight device of Comparative Example 1 which is a case without use of a light deflecting layer as a prism sheet.

FIG. 7 is a drawing showing a backlight device according to an embodiment of the present invention.

FIG. 8 is a drawing showing a luminance measuring method in an embodiment of the present invention.

FIG. 9 is the measurement results of an angular distribution of luminance of emitted light from the light guide plate in the backlight device in Example 4.

FIG. 10 is a drawing showing an angular distribution of luminance of emitted light from the light guide plate in the backlight device of Comparative Example 2.

### DESCRIPTION OF EMBODIMENTS

An embodiment of the present invention will be described below in detail. In the description of the drawings, the same elements will be denoted by the same reference signs, without redundant description. Dimensional ratios in the drawings do not always agree with those in the description.

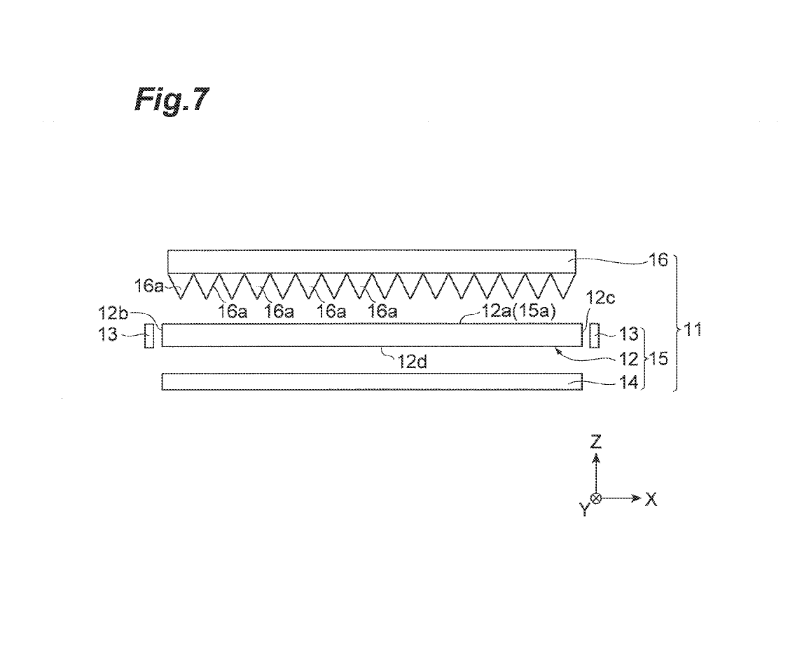

FIG. 7 shows a backlight device according to an embodiment of the present invention. A backlight device 11 according to an embodiment to the present invention is provided with a light deflecting layer 16, light sources 13, a light guide plate 12, and a reflective sheet 14. The light sources 13, light guide plate 12, and reflective sheet 14 constitute a surface emitting part 15 which generates light of a planar shape. In the configuration shown in FIG. 7, a light exit surface 12a corresponds to a light exit surface 15a of the surface emitting part 15. The light guide plate 12 and the light deflecting layer 16 are arranged along a predetermined direction so that the light of the planar shape emitted from the light guide plate 12 is incident to the light deflecting layer 16. For convenience′ sake of description, the foregoing “predetermined direction” is referred to as z-axis direction (first direction) and two directions perpendicular to the z-axis direction are referred to as x-axis direction (second direction) and y-axis direction (third direction). The x-axis direction and the y-axis direction bisect at right angles.

The light sources 13 are arranged on end faces 12b, 12c of the light guide plate 12. However, the light source 13 may be arranged on only one of the end faces 12b, 12c, or on another end face of the light guide plate 12. The reflective sheet 14 is installed on the lower surface 12d side (the opposite side to the exit) of the light guide plate 12. This reflective sheet 14 returns light emitted from the lower surface 12d of the light guide plate 12 (leaking light), toward the light guide plate 12.

The light guide plate 12 is comprised of an optically transparent material. For example, the light guide plate 12 is comprised of a methacrylate resin, a polycarbonate resin, a polyester resin, a cyclic polyolefin resin, or the like. Printed dots, linear V-grooves, or the like may be formed on the surface of the light guide plate 12, in order to adjust an in-plane distribution of light quantity of light emitted from the light exit surface 12a.

The light sources 13 may be either of linear light sources and point light sources. For example, cold cathode tubes, light emitting diodes (LEDs), or the like can be used as the light sources 13. In the case where the light sources 13 are LEDs, each LED may be, for example, a white emitting LED with three LED chips to emit respective colors of red, blue, and green, or, may be an LED consisting of three connected and integrated LEDs to emit respective colors of red, blue, and green. Furthermore, the LEDs may also be LEDs to emit white light by a combination of a blue emitting LED chip or a near-ultraviolet emitting LED chip with a phosphor.

The light deflecting layer 16 is arranged on the light exit surface 12a side of the light guide plate 12. The light deflecting layer 16 is a prism sheet. The light deflecting layer 16 as the prism sheet has a large number of prisms 16a extending in a direction (the y-axis direction in FIG. 7) parallel to the sides where the light sources 13 are arranged in a rectangular light emitting surface of the backlight device 11. The large number of prisms 16a face the light guide plate 12. A cross section of the light deflecting layer 16 cut by a plane (plane perpendicular to the y-axis direction) normal to the sides where the light sources 13 are arranged in the rectangular light emitting surface of the backlight device 11 has a shape in which a plurality of triangles lie in a row. The plurality of triangles lie in a row so that the bases thereof are aligned on a straight line. In other words, the cross-sectional shape of the prism 16a in the extending direction of the prism 16a is a triangular shape, and the plurality of prisms 16a lie in a row so that the bases in their cross sections are aligned on the straight line. The light deflecting layer 16 as the prism sheet is installed with the vertex of the triangle other than those on the base being located on the light guide plate 12 side, in the cross section of each prism 16a in the extending direction of the prism 16a.

In the backlight device 11, the surface emitting part 15 composed of the light guide plate 12, the light sources 13, and the reflective sheet 14 is configured so that when the light emitted from the light exit surface 12a of the light guide plate 12 is measured at all of four predetermined azimuths Ψ with respect to a direction (the x-axis direction) from the light source 13 to the light guide plate 12 in a plane perpendicular to the z-axis direction, the luminance of the light emitted from the light guide plate 12 satisfies a predetermined condition.

In an example of luminance measuring methods, the surface emitting part 15 is arranged so that the x-axis direction agrees with the vertical direction. For example, the surface emitting part 15 is arranged so that a direction from the end face 12b to the end face 12c (in other words, a direction from the light source 13 on the end face 12b side to the light guide plate 12) becomes upward in the vertical direction. In this case, when the upward direction in the vertical direction (the x-axis direction) is defined as the azimuth 0°, the four predetermined azimuths Ψ are a first azimuth Ψ1 being the angle of 0° with respect to the upward direction, a second azimuth Ψ2 being the angle of 45° with respect to the upward direction, a third azimuth Ψ3 being the angle of 90° with respect to the upward direction, and a fourth azimuth Ψ4 being the angle of 135° with respect to the upward direction. When the x-axis direction is set along the vertical direction, the z-axis direction is substantially the horizontal direction.

In the measurement of the light emitted from the light guide plate 12, the luminance of the light emitted from the light guide plate 12 is measured at a predetermined distance from a measurement target point in the light exit surface 12a, at all of the first to fourth azimuths Ψ1 to Ψ4, in a range of visual angle of −40° to +40° with respect to a direction of a normal (the z-axis direction) to the light exit surface 12a and in ranges of vision of −60° to −74° and +60° to +74° as well. The aforementioned condition in the light guide plate 12 is that all luminance values in the range of vision of −40° to +40° at all the first to fourth azimuths Ψ1 to Ψ4 are not more than 40% of a maximum of luminance values in the ranges of vision of −60° to −74° and +60° to +74° at all the first to fourth azimuths Ψ1 to Ψ4. Preferably, all the luminance values in the range of vision of −40° to +40° at all the first to fourth azimuths Ψ1 to Ψ4 are not more than 15% of the maximum of the luminance values in the ranges of vision of −60° to −74° and +60° to +74° at all the first to fourth azimuths Ψ1 to Ψ4.

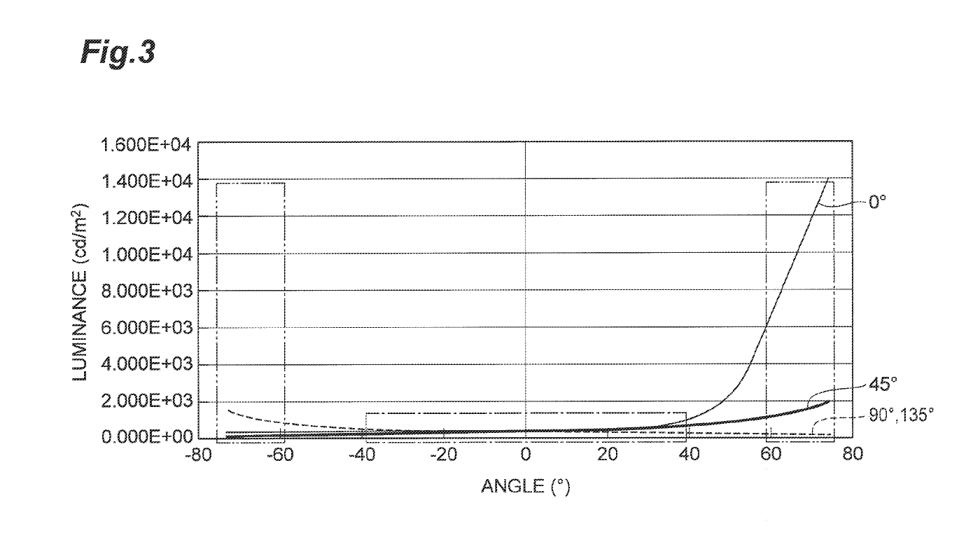

FIG. 3 is an example of an angular distribution of luminance of the emitted light from the light guide plate 12 satisfying the predetermined condition. FIG. 3 shows the results of the measurement of the light emitted from the light guide plate 12 at the first to fourth azimuths Ψ1 to Ψ4. The axis of abscissa in FIG. 3 represents angles (°) indicative of vision with respect to the direction of the normal (the z-axis direction) to the light exit surface 12a, and the axis of ordinate luminance values (cd/m²). Of curves indicating the measurement results of luminance values, a solid line shows the measurement results at 0° of the first azimuth Ψ1, a thick solid line the measurement results at 45° of the second azimuth Ψ2, and a dashed line the measurement results at 90° of the third azimuth Ψ3 and at 135° of the fourth azimuth Ψ4. In FIG. 3, since the results of the third azimuth Ψ3 and the fourth azimuth Ψ4 overlap each other, the results of the third azimuth Ψ3 and the fourth azimuth Ψ4 are indicated by the same dashed line. Rectangles depicted by chain double-dashed lines given at the left and right ends of FIG. 3 show the ranges of vision of −60° to −74° and +60° to +74°. A rectangle depicted by a chain line near the central bottom of FIG. 3 shows the range of vision of −40° to +40°.

In the measurement results of luminance shown in FIG. 3, a maximum of the luminance values in the ranges of vision of −60° to −74° and +60° to +74° appears at the azimuth 0° (the first azimuth Ψ1) and the maximum is 1.4×10⁴ in the unit of the axis of ordinate in FIG. 3. All the luminance values in the range of vision of −40° to +40° at all the first to fourth azimuths Ψ1 to Ψ4 are approximately 1.5×10³ in the unit of the axis of ordinate in FIG. 3. Therefore, all the luminance values in the range of vision of −40° to +40° at all the first to fourth azimuths Ψ1 to Ψ4 are not more than 40% (5.6×10³) of the maximum 1.4×10⁴ and also not more than 15% (2.1×10³) thereof.

A preferred embodiment of the light guide plate 12 is a light guide plate that is a plate having a trapezoid cross section. In the light guide plate 12 having the trapezoid cross section, the end faces 12b, 12c are end faces corresponding to the upper base (shorter side) and the lower base (longer side), respectively, of the trapezoid. Therefore, the thickness decreases from the end face 12b to the end face 12c. In an embodiment, the light exit surface 12a is approximately perpendicular to each of the end faces 12b, 12c. The light guide plate 12 being the plate having the trapezoid cross section can be designed so as to satisfy the aforementioned condition, for example, by adjusting an intersecting angle of the surface (the surface on the reflective sheet 14 side) opposite to the light exit surface 12a of the light guide plate 12 with the z-axis direction, and/or, by forming printed dots, V-grooves, or the like on the surface of the light guide plate 12, as described above.

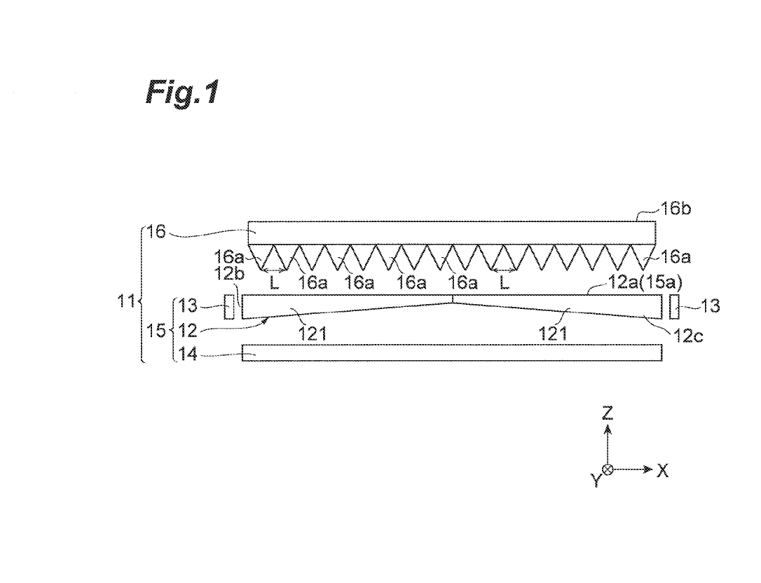

The light guide plate 12 as a more preferred embodiment has such a shape that two plates 121, 121 having respective trapezoid cross sections are integrated while the upper bases (shorter bases) of trapezoids are in contact so as to be shared (FIG. 1). In the light guide plate 12 having the shape in which the two plates 121, 121 are integrated as described above, the light exit surface 12a is comprised of planes corresponding to sides in the trapezoid cross sections of the respective plates 121, 121. The end faces 12b, 12c of the light guide plate 12 are faces corresponding to the lower bases in the cross sections of the respective plates 121, 121. Therefore, in the light guide plate 12 of the configuration in which the plates 121, 121 are joined, the thickness decreases from the end faces 12b, 12c to the central part, as illustrated in FIG. 1. Each of the two plates 121, 121 is arranged so that the light exit surface 12a of the light guide plate 12 is substantially perpendicular to the z-axis direction. The light guide plate 12 composed of the plates 121, 121 joined can be designed so as to satisfy the aforementioned condition, for example, by adjusting an intersecting angle of the surface (the surface on the reflective sheet side) opposite to the light exit surface 12a in each of the two plates 121, 121 forming the light guide plate 12, with the z-axis direction, and/or, by forming printed dots, V-grooves, or the like on the surface of the light guide plate 12.

Examples of a material of the light deflecting layer 16 include a polycarbonate resin, an ABS resin, a methacrylate resin, a methyl methacrylate-styrene copolymer resin, a polystyrene resin, an acrylonitrile-styrene copolymer resin, and a polyolefin resin such as polyethylene or polypropylene. The prism film can be manufactured by a well-known method such as the profile extrusion method, press molding method, injection molding method, roll transfer method, laser ablation method, mechanical cutting method, mechanical polishing method, or photopolymer process.

When the photopolymer process is applied, a so-called ionization radiation curable resin can be used as the material. Examples of the ionization radiation curable resin include multifunctional acrylates such as acrylic ester or methacrylic ester of polyalcohol. Other examples of the ionization radiation curable resin include multifunctional urethane acrylates as synthesized from diisocyanate and, for example, hydroxyester derived from polyalcohol and acrylic acid or hydroxyester derived from polyalcohol and methacrylic acid. These methods may be used each singly or in a combination of two or more methods thereof. The thickness of the light deflecting layer 16 is normally from 0.05 to 5 mm and preferably from 0.1 to 2 mm. A distance L between ridge lines of the respective prisms 16a is normally in the range of 10 to 500 μm and preferably in the range of 30 to 200 μm.

The reflective sheet 14 to be used herein is a white sheet or a sheet of a mirror type or the like. The white sheet is a sheet that diffuses light, by adding fillers in a resin film of polyester or the like or by forming voids between added fillers and a base resin. The sheet of the mirror type is a sheet in which specularly reflected components are enhanced by evaporating metal such as aluminum and silver on a surface of a resin film of polyester or the like. The mirror type is more preferred in view of achievement of higher front luminance. An example of the reflective sheet 14 of the mirror type is a sheet with a smooth metal-deposited surface having no fine unevenness, which provides only specularly reflected components of reflected light but no diffusely reflected components. An example of the reflective sheet 14 of the mirror type is a reflective sheet 14 with a mirror-finished surface.

The backlight device 11 including the light guide plate 12 meeting the aforementioned condition in the measurement of the light emitted from the light guide plate 12 provides a liquid crystal display device with high luminance when viewed from the front thereof, by combining the backlight device 11 with a liquid crystal cell normally used in industrial production.

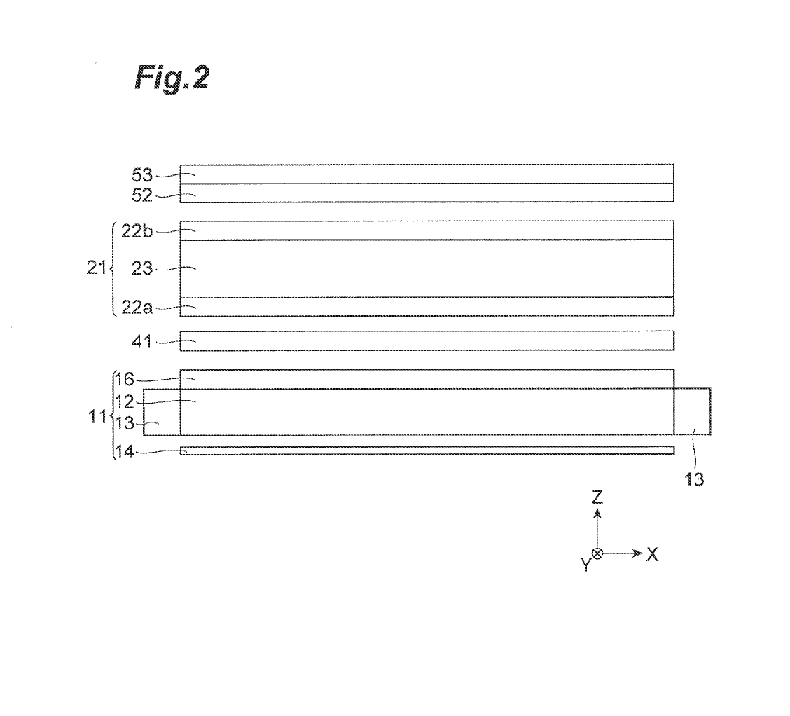

FIG. 2 schematically shows a liquid crystal display device equipped with the backlight device according to an embodiment of the present invention. The liquid crystal display device is provided with a liquid crystal cell 21 produced by locating a liquid crystal layer 23 between a pair of transparent substrates 22a, 22b. A first polarizing plate 41, the liquid crystal cell 21, and a second polarizing plate 52 are arranged in the order named from the backlight device 11 side, between the backlight device 11 and the liquid crystal cell 21.

The liquid crystal cell 21 used in the liquid crystal display device manufactured by using the backlight device 11 according to an embodiment of the present invention is provided with the pair of transparent substrates 22a, 22b opposed to each other with a space of a predetermined distance, and the liquid crystal layer 23 prepared by enclosing a liquid crystal between this pair of transparent substrates 22a, 22b. Although not shown in FIG. 2, a transparent electrode and an oriented film are laminated on each of the pair of transparent substrates 22a, 22b and the liquid crystal is oriented when a voltage based on display data is applied between the transparent electrodes. A display method of the liquid crystal cell 21 can be adopted from display methods such as the TN method, IPS method, and VA method.

The first polarizing plate 41 to be used is normally one in which support films are bonded to both surfaces of a polarizer. Examples of the polarizer include those in which a dichromatic dye or iodine is adsorbed and oriented on a polarizer substrate of a polyvinyl alcohol-based resin, a polyvinyl acetate resin, an ethylene/vinyl acetate (EVA) resin, a polyamide resin, a polyester resin, or the like; and a polyvinyl alcohol/polyvinylene copolymer having oriented molecular chains of a dichromatic dehydration product of polyvinyl alcohol (polyvinylene) in a molecularly oriented polyvinyl alcohol film. Particularly, a preferably used polarizer is the one in which a dichromatic dye or iodine is adsorbed and oriented on a polarizer substrate of a polyvinyl alcohol-based resin. The thickness of the polarizer is, generally for the purpose of reduction in thickness of the polarizer or the like, preferably not more than 100 μm, more preferably in the range of 10 to 50 μm, and still more preferably in the range of 25 to 35 μm.

The support films for supporting and protecting the polarizer are preferably films consisting of a polymer with low birefringence and with superior transparency, mechanical strength, thermal stability, and water impermeability.

Examples of such films include films obtained by subjecting to a forming process into film, a resin such as a cellulose acetate-based resin like TAC (triacetylcellulose), an acrylic resin, a fluorine-based resin like a tetrafluoroethylene/hexafluoropropylene-based copolymer, a polycarbonate resin, a polyester-based resin like polyethylene terephthalate, a polyimide-based resin, a polysulfone-based resin, a polyether sulfone-based resin, a polystyrene-based resin, a polyvinyl alcohol-based resin, a polyvinyl chloride-based resin, a polyolefin resin, or a polyamide-based resin.

Among these, triacetylcellulose films or norbornene-based thermoplastic resin films with surfaces saponified with an alkali can be preferably used in terms of polarization characteristics, durability, and so on. Since the norbornene-based thermoplastic resin films serve as good barriers against heat and moist heat, they significantly improve the durability of the polarizing plate 41 and also significantly improve the dimensional stability because of low moisture absorptivity. For this reason, the norbornene-based thermoplastic resin films can be particularly preferably used.

The forming process into film to be used can be a conventionally known method such as the casting method, calendaring method, or extrusion method. There are no restrictions on the thickness of the support films. However, in view of reduction in thickness of the polarizing plate 41 or the like, the thickness of the support films is preferably not more than 500 μm, more preferably in the range of 5 to 300 μm, and still more preferably in the range of 5 to 150 μm.

The second polarizing plate 52 is one to be paired with the first polarizing plate 41 arranged on the back side of the liquid crystal cell 21. The second polarizing plate 52 to be preferably used herein can also be one of the examples of the first polarizing plate 41. However, the second polarizing plate 51 is arranged so that its polarization plane is perpendicular to the polarization plane of the first polarizing plate 41.

An anti-glare layer 53 may be provided on the second polarizing plate 52 by applying a resin solution in which microscopic fillers are dispersed, onto the second polarizing plate 52 and forming fine unevenness on a surface of a base material in such a manner that the fillers are exposed in a surface of the applied film by controlling the thickness of the applied film.

The surface of the anti-glare layer 53 normally has fine unevenness but may have no fine unevenness. Or, the fine unevenness may be formed on the surface of the base film as the anti-glare layer 53, without use of the microscopic fillers. The fine unevenness may be formed on the surface of the base film by a method of processing the surface of the base film by sand blasting, embossing, and so on, a method of forming fine unevenness in a step of producing the base film, using a die or an emboss roll with a die surface having an inversion of the unevenness.

Namely, the anti-glare layer 53 may have a light diffusing function by only internal diffusion (internal haze), may have the light diffusing function by both of internal diffusion (internal haze) and surface diffusion (external haze and unevenness), and may have the light diffusing function by only surface diffusion (external haze and unevenness).

The liquid crystal display device manufactured with the backlight device 11 according to an embodiment of the present invention may have an optically functional film with another function.

Examples of such optically functional film include a reflective polarizing film that transmits a certain kind of polarized light but reflects polarized light demonstrating a property opposite thereto, a film with a diffusion function having a random uneven shape on a surface, a film with a deflecting function having an uneven shape such as prisms or lenticular lenses on a surface, and so on. Examples of commercially available products corresponding to the reflective polarizing film to transmit a certain kind of polarized light but reflect polarized light demonstrating the property opposite thereto include “DBEF” (which is manufactured by 3M and is available from Sumitomo 3M Limited in Japan). Examples of commercially available products corresponding to the film with the diffusion function include “OPALUS” (manufactured by KEIWA Incorporated). Examples of commercially available products corresponding to the film with the deflecting function include “BEF” (which is manufactured by 3M and is available from Sumitomo 3M Limited in Japan).

### EXAMPLES

The present invention will be described below in more detail with examples, but it should be noted that the present invention is by no means intended to be limited to these.

### Example 1

FIG. 1 shows a configuration of the backlight device of the present example. The backlight device 11 of the present example was constructed by modifying the backlight device used in a 32-inch LCD television KDL-32EX700 manufactured by SONY Corporation, so as to replace the light guide plate originally incorporated in the backlight device used in the SONY 32-inch LCD television KDL-32EX700, with the light guide plate incorporated in a 16.4-inch notebook PC VGN-FW73JGB manufactured by SONY Corporation. The cross-sectional shape of the light guide plate incorporated in the 16.4-inch notebook PC VGN-FW73JGB was a trapezoid.

A manufacturing method of the backlight device 11 of the present example will be specifically described. The light guide plate 12 used in the backlight device 11 of the present Example 1 was prepared as follows. Namely, when the light guide plate incorporated in the SONY 16.4-inch notebook PC VGN-FW73JGB is referred to as light guide plate 121, two light guide plates 121, 121 were bonded with a solvent between end faces of the light guide plates 121, 121 corresponding to the upper bases of trapezoids in their cross-sectional shape, thereby obtaining a so-called butterfly light guide plate 12. This butterfly light guide plate 12 was placed in exchange for the light guide plate originally incorporated in the backlight device used in the SONY 32-inch LCD television KDL-32EX700, to obtain the backlight device 11 of the present example. The reflective sheet incorporated in the backlight device used in the SONY 32-inch LCD television KDL-32EX700 was the reflective sheet of the white diffusion type.

The light deflecting layer 16 in the backlight device 11 of Example 1 was a prism sheet. The cross-sectional shape of the large number of prisms 16a of the light deflecting layer 16 as the prism sheet was isosceles triangles with the vertex angle of 60°. The distance L between ridge lines of adjacent prisms 16a was 50 μm. In the light deflecting layer 16 as the prism sheet, the surface 16b opposite to the surface on which the prisms 16a were formed, was a flat surface. The surface roughness values of the surface 16b measured according to JIS B0601-1994 were as follows.

Ra (center-line average roughness); 0.01 μm

Rz (ten-point average roughness); 0.08 μm

The light deflecting layer 16 was installed, as shown in FIG. 1, so that the side where the prisms 16a were formed was located on the light sources 13 side and so that the ridge lines of the prisms 16a were directed in parallel with the end faces 12b, 12c on which the light sources 13 were arranged. In other words, the prisms 16a extend in the y-axis direction.

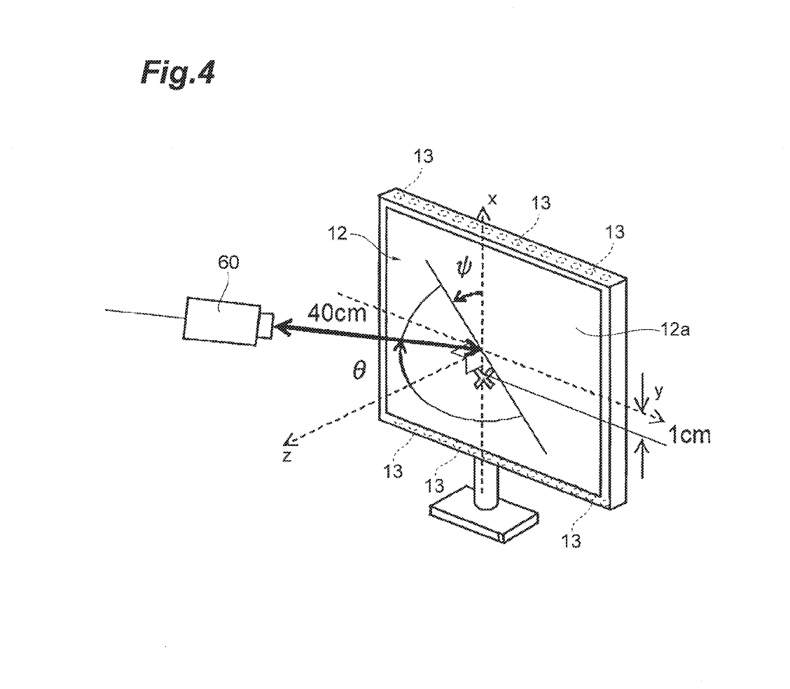

FIG. 4 is a drawing showing a luminance measuring method. In the luminance measurement, the luminance was measured without the light deflecting layer 16, in order to measure the luminance of light from the surface emitting part 15. Therefore, in the luminance measurement, the light emitting surface of the backlight device 11 is the light exit surface 15a of the surface emitting part 15. The light exit surface 15a of the surface emitting part 15 corresponds to the light exit surface 12a of the light guide plate 12.

As shown in FIG. 4, the backlight device 11 (backlight module) was set upright so that the light emitting surface of the backlight device 11 before incorporation of the light deflecting layer 16 (the backlight device 11 corresponding to a configuration obtained by removing the light deflecting layer 16 from the state of FIG. 1) became vertical. FIG. 4 shows the state before incorporation of the light deflecting layer 16 in the backlight device 11. In other words, it shows a state in which a unit with the light sources 13 being arranged on the light guide plate 12 is incorporated in a housing. An angle with respect to a normal to the light emitting surface (angle to the z-axis direction) was defined as θ, a luminance meter 60 was set in a direction at a predetermined angle θ, and the luminance was measured at a portion (measurement target point) 1 cm above a center of the light emitting surface. The reason why the measurement point was set 1 cm off above the center of the light emitting surface is to prevent an abnormal value that can occur if the measurement was carried out at the center of the light emitting surface. At this time, the distance between the measurement point and the luminance meter 60 was set to 40 cm, and the luminance was measured at 2° intervals in the range of the measurement angle θ of −74° to 74°. The luminance meter 60 used was BM-7 manufactured by TOPCON Corporation and an angle of measurement of the luminance meter was set to 1°.

The luminance was measured at the azimuths IP in four directions of 0°, 45°, 90°, and 135° with respect to the upward direction in FIG. 4 defined as 0°.

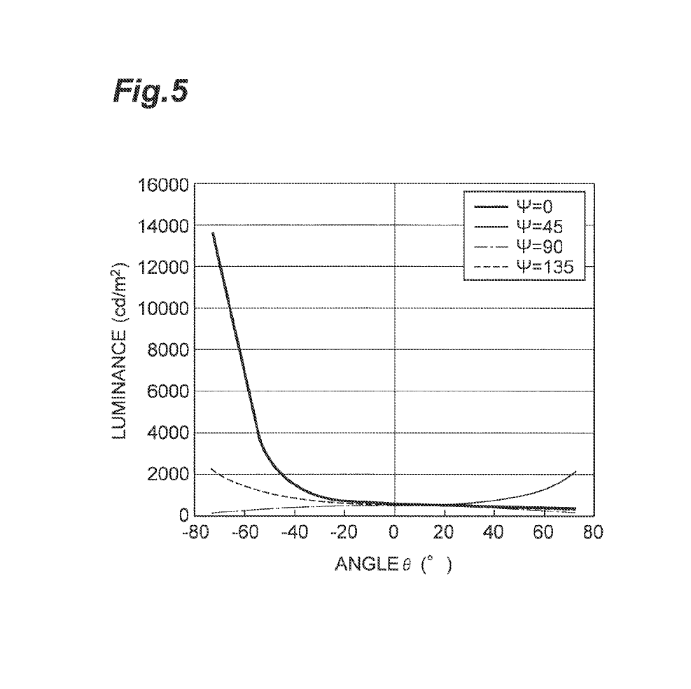

FIG. 5 shows an angular distribution from the backlight device 11 measured as described above. Values of a maximum in the range of −40° to 40° and a maximum in the ranges of −60° to −74° and 60° to 74° are as follows.

Maximum in the range of −40° to 40°; Max1=1479 cd/m² (at 40°)

Maximum in the ranges of −60° to −74° and 60° to 74°; Max2=13707 cd/m² (at −74°)

As a result, the following relation was obtained:

Max1/Max2=11%<45%.

The front luminance was measured with the backlight device 11 in the state in which the light deflecting layer 16 as the prism sheet was incorporated. The front luminance measured was 3852 cd/m².

### Example 2

The luminance was measured in the same manner as in Example 1, except that the light deflecting layer 16 used was one as the prism sheet the cross-sectional shape of the prisms 16a of which was isosceles triangles with the vertex angle thereof being 65°. The front luminance at this time was 4090 cd/m².

### Example 3

The luminance was measured in the same manner as in Example 1, except that the light deflecting layer 16 used was one as the prism sheet the cross-sectional shape of the prisms 16a of which was isosceles triangles with the vertex angle thereof being 70°. The front luminance at this time was 2661 cd/m².

### Comparative Example 1

The backlight device was constructed in the same configuration as the backlight device 11 in Example 1, except that the light guide plate originally used in KDL-32EX700 was adopted in place of the light guide plate 12 of the backlight device 11 in Example 1 and that the light deflecting layer adopted was that as the same prism sheet as in Example 2 (i.e., the prism sheet with the vertex angle of 65°). The luminance was measured in the same manner as in Example 1, with the backlight device of Comparative Example 1. Therefore, the luminance was also measured without the light deflecting layer in Comparative Example 1 as in Example 1.

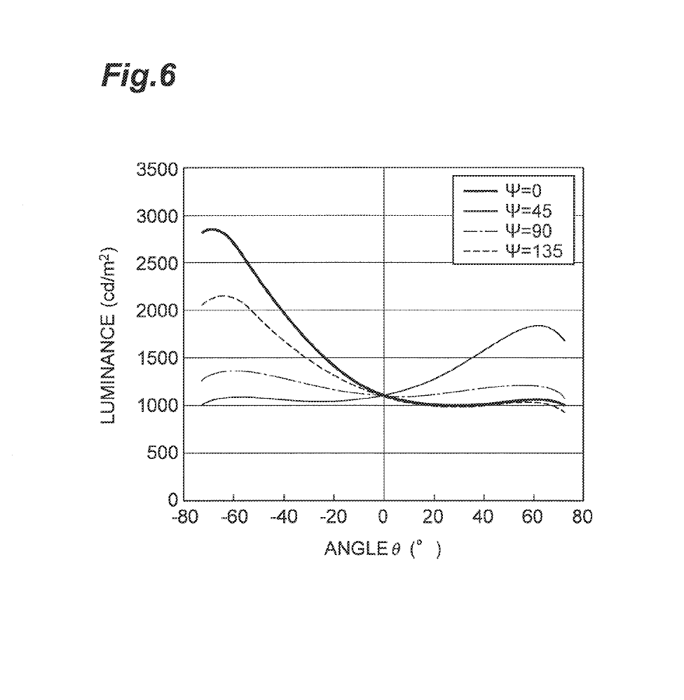

An angular distribution of luminance in the case of only the backlight (without use of the light deflecting layer as the prism sheet) is shown in FIG. 6. Values of a maximum in the range of −40° to 40° and a maximum in the ranges of −60° to −74° and 60° to 74° are as follows.

Maximum in the range of −40° to 40°; Max1=1963 cd/m² (at 40°)
Maximum in the ranges of −60° to −74° and 60° to 74°; Max2=2868 cd/m² (at −72°)

As a result, the following relation was obtained:

Max2/Max2=68%>45%.

The front luminance with the use of the light deflecting layer as the prism sheet was 1870 cd/m².

### Example 4

The backlight device 11 of the present example was fabricated in the configuration shown in FIG. 7, in which the light deflecting layer 16 as the same prism sheet as that used in Example 1, and a reflective plate (reflective sheet 14) having a surface of the mirror type were installed for a set of the backlight sources and the light guide plate manufactured by Samsung Electronics Co. Ltd. The light deflecting layer 16 was installed, as shown in FIG. 7, so that the surface where the prisms 16a were formed was located on the light guide plate 12 side (or the side where the light sources 13 exist) and so that the ridge lines of the prisms 16a were directed in parallel with the end faces of the light guide plate 12 where the light sources 13 were arranged. In other words, the light deflecting layer 16 was arranged so that the prisms 16a extended in the y-axis direction in FIG. 7.

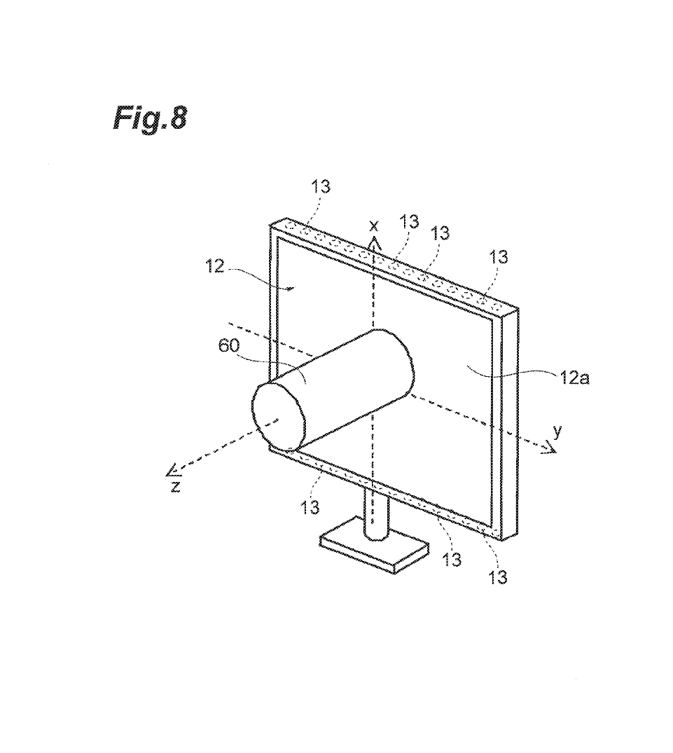

FIG. 8 shows a luminance measuring method. In the present example, as in Example 1, the backlight device 11 (backlight module) was also set upright so that the light emitting surface of the backlight device 11 before incorporation of the light deflecting layer 16 (the backlight device 11 corresponding to a configuration obtained by removing the light deflecting layer 16 from the state of FIG. 7) became vertical.

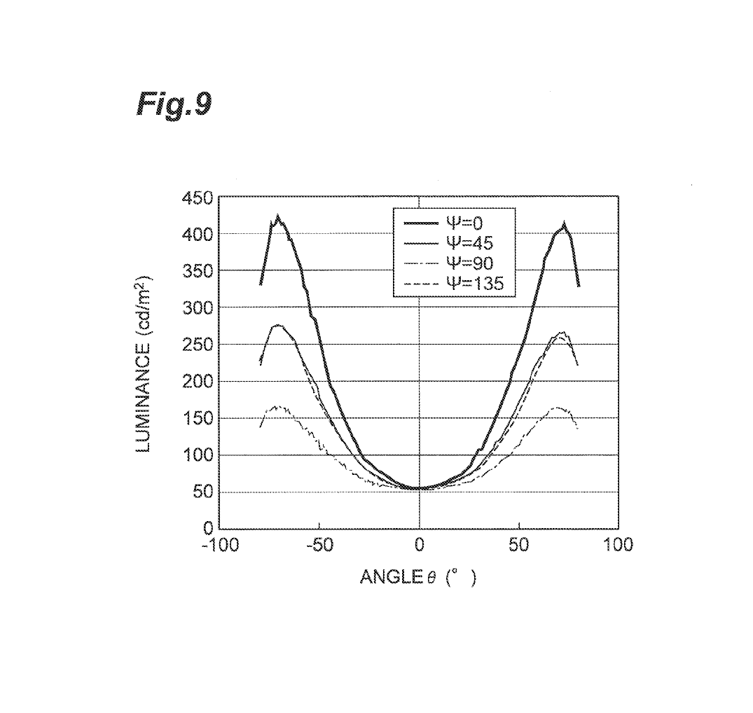

EZ-Contrast 160R manufactured by ELDIM Company was used as luminance meter 60. The luminance was measured at 1° intervals in the range of θ of −80° to 80° at Ψ of 0°, 45°, 90°, and 135° with an opening part of the luminance meter 60 in contact with the center of the light emitting surface of the backlight device 11 of the present example. In the present example the foregoing light emitting surface also corresponds to the light exit surface 12a of the light guide plate 12, as in the case of Example 1. An angular distribution from the backlight device 11 at this time is shown in FIG. 9. Values of a maximum in the range of −40° to 40° and a maximum in the ranges of −60° to −74° and 60° to 74° are as follows.

Maximum in the range of −40° to 40°; Max1=164 cd/m² (at 40°

Maximum in the ranges of −60° to −74° and 60° to 74°; Max2=418 cd/m² (at −74°)

As a result, the following relation was obtained:

Max1/Max2=39%<45%.

Furthermore, the front luminance was measured in the state in which the prism sheet as the light deflecting layer 16 was incorporated. The front luminance measured was 342 cd/m².

### Comparative Example 2

The luminance was measured in the same manner as in Example 4, except that the reflective plate (reflective sheet) was replaced with one having a surface of the white diffusion type.

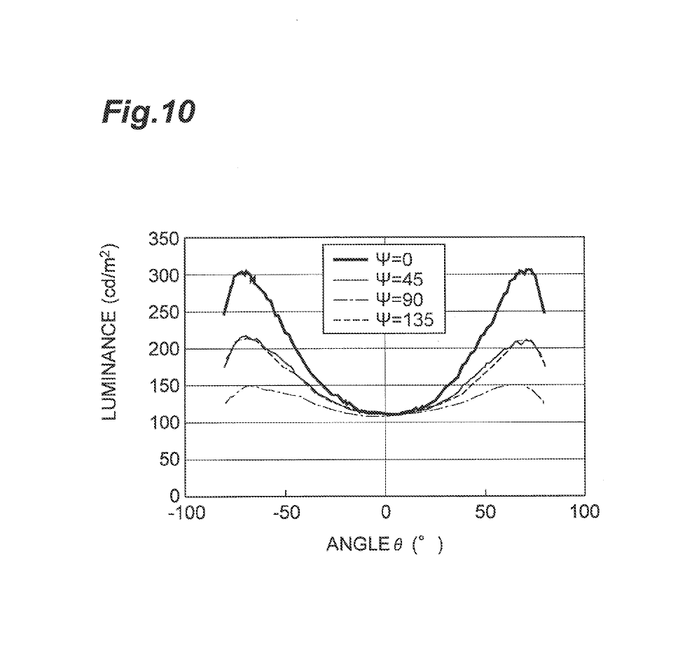

An angular distribution of luminance from the backlight at this time is shown in FIG. 10. The luminance from the backlight is the luminance from the light emitting surface of the backlight device without the light deflecting layer as the prism sheet and luminance of light emitted from the light exit surface of the light guide plate, as in the case of Examples 1, 4 and others. Values of a maximum in the range of −40° to 40° and a maximum in the ranges of −60° to −74° and 60° to 74° are as follows.

Maximum in the range of −40° to 40°; Max1=183 cd/m² (at 40°)

Maximum in the ranges of −60° to −74° and 60° to 74°; Max2=308 cd/m² (at −73°)

As a result, the following relation was obtained:

Max1/Max2=59%>45%.

Next, the front luminance was measured with the backlight device in which the same light deflecting layer as that used in Example 1 was arranged as a prism sheet. The installation condition of the light deflecting layer is the same as in the case of Example 4.

The measured front luminance was 294 cd/m².

The above described the embodiments and examples of the present invention but it should be noted that the present invention is not limited to the embodiments and examples and can be modified in many ways without departing from the spirit and scope of the invention. For example, it is sufficient in the present invention for the surface emitting part to satisfy the aforementioned predetermined condition at the four azimuths Ψ1 to Ψ4, as described above. The condition may be adjusted depending upon the configuration of the light guide plate 12 or may be adjusted depending upon the reflection condition of the reflective sheet 14. The surface emitting part 15 may be configured so that at least one other optical sheet is arranged on the light guide plate 12. In this case, a light exit surface of an optical sheet closest to the light deflecting layer 16 out of other optical sheets on the light guide plate 12 is the light emitting surface of the backlight device during the luminance measurement, which was described by making use of FIG. 4 and FIG. 8. When the surface emitting part 15 has an optical sheet as described above, the foregoing predetermined condition can be satisfied by making use of optical characteristics of the optical sheet.

### REFERENCE SIGNS LIST

11 backlight device
12 light guide plate
13 light sources
12a light exit surface (light exit surface of light guide plate)
15 surface emitting part
15a light exit surface (light exit surface of surface emitting part)
16 light deflecting layer
21 liquid crystal cell
22a transparent substrate
22b transparent substrate
41 first polarizing plate
52 second polarizing plate
53 anti-glare layer

1. A backlight device comprising:
a surface emitting part which emits light of a planar shape from a light exit surface; and
a light deflecting layer which is provided on the surface emitting part and to which the light from the light exit surface is incident,
wherein the surface emitting part has:
a light guide plate;
a light source arranged on an end face of the light guide plate; and
a reflective sheet arranged on a side opposite to the light deflecting layer side with respect to the light guide plate, and
wherein, in the case where, at a first azimuth, a second azimuth, a third azimuth, and a fourth azimuth in a plane perpendicular to a first direction being a direction from the surface emitting part to the light deflecting layer, the first to fourth azimuths being angles of 0°, 45°, 90°, and 135°, respectively, with respect to a second direction being a direction from the light source to the light guide plate, luminance of the light emitted from the light exit surface is measured at a predetermined distance from a measurement target point on the light exit surface in ranges of vision of −40° to +40°, −60° to −74°, and +60° to +74° with respect to the first direction, all luminance values in the range of vision of −40° to +40° at all the first to fourth azimuths are not more than 40% of a maximum of luminance values in the ranges of vision of −60° to −74° and +60° to +74° at all the first to fourth azimuths.

2. The backlight device according to claim 1, wherein all the luminance values in the range of vision of −40° to +40° at all the first to fourth azimuths are not more than 15% of the maximum of the luminance values in the ranges of vision of −60° to −74° and +60° to +74° at all the first to fourth azimuths.

3. The backlight device according to claim 1, wherein the light guide plate is a plate having a trapezoid cross section.

4. The backlight device according to claim 1, wherein the light guide plate is a light guide plate having such a shape that two plates having respective trapezoid cross sections are integrated while the upper bases of trapezoids are in contact so as to be shared.

5. The backlight device according to claim 1, wherein the reflective sheet is of a mirror type.

6. The backlight device according to claim 1, wherein the light deflecting layer is a prism sheet having a plurality of prisms on the surface emitting part side,
wherein each of the plurality of prisms extends in a third direction being a direction perpendicular to the first and second directions,
wherein a shape of a cross section perpendicular to the third direction of each of the plurality of prisms is a triangle,
wherein the plurality of prisms are arranged in parallel in the second direction,
wherein the vertices of the triangles being the shapes of the cross sections of the respective prisms are located on the surface emitting part side, and
wherein the bases of the triangles being the shapes of the cross sections of the respective prisms lie in a row on a straight line.
